(19) United States
(12) Patent Application Publication
(10) Pub. No.: US 2007/0086406 A1
(43) Pub. Date: Apr. 19, 2007

(54) Methods for Assigning Resources in a Communication System

(75) Inventor: Aris Papasakellariou, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/535,867

(22) Filed: Sep. 27, 2006

Related U.S. Application Data
(60) Provisional application No. 60/723,175, filed on Oct. 3, 2005.

(51) Int. Cl. H04J 1/00

(52) U.S. Cl. 370/343; 370/480

(57) ABSTRACT

Embodiments of the invention provide methods for assigning resources to Node Bs for communication with a plurality of user equipments (UEs) in each Node B. A central node receives metrics indicating requirement for resources and the central node communicates with each of the Node Bs information regarding the resources. Alternatively, these resources may be assigned, without communication with a central node, based on long term statistics in each Node B and be periodically re-configured. The aforementioned resources can be frequency resources, time resources, or both.

### CROSS-REFERENCE TO RELATED APPLICATIONS

This application claims priority to and incorporates by reference U.S. Provisional Application No. 60/723,175, filed Oct. 03, 2005, entitled “Methods for Interference Avoidance near the Cell Edge”, Aris Papasakellariou inventor.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Embodiments of the invention are directed, in general, to communication systems and, more specifically, to avoiding interference near the edge of cells in a communication system.

The global market for both voice and data communication services continues to grow as does users of the systems which deliver those services. As communication systems evolve, system design has become increasingly demanding in relation to equipment and performance requirements. Future generations of communication systems, will be required to provide high quality high transmission rate data services in addition to high quality voice services. Orthogonal Frequency Division Multiplexing (OFDM) is a technique that will allow for high speed voice and data communication services.

Orthogonal Frequency Division Multiplexing (OFDM) is based on the well-known technique of Frequency Division Multiplexing (FDM). OFDM technique relies on the orthogonality properties of the fast Fourier transform (FFT) and the inverse fast Fourier transform (IFFT) to eliminate interference between carriers. At the transmitter, the precise setting of the carrier frequencies is performed by the IFFT. The data is encoded into constellation points by multiple (one for each carrier) constellation encoders. The complex values of the constellation encoder outputs are the inputs to the IFFT. For wireless transmission, the outputs of the IFFT are converted to an analog waveform, up-converted to a radio frequency, amplified, and transmitted. At the receiver, the reverse process is performed. The received signal (input signal) is amplified, down converted to a band suitable for analog to digital conversion, digitized, and processed by a FFT to recover the carriers. The multiple carriers are then demodulated in multiple constellation decoders (one for each carrier), recovering the original data. Since an IFFT is used to combine the carriers at the transmitter and a corresponding FFT is used to separate the carriers at the receiver, the process has potentially zero inter-carrier interference such as when the sub-carriers are separated in frequency by an amount larger than the maximum expected Doppler shift.

FIG. 1 is a diagram illustrative of the Frequency 103—Time 101 Representation 100 of an OFDM Signal. In FDM different streams of information are mapped onto separate parallel frequency channels 140. Each FDM channel is separated from the others by a frequency guard band to reduce interference between adjacent channels.

The OFDM technique differs from traditional FDM in the following interrelated ways:
1. multiple carriers (called sub-carriers 150) carry the information stream;
2. the sub-carriers 150 are orthogonal to each other; and
3. a Cyclic Prefix (CP) 110 (also known as guard interval) is added to each symbol 120 to combat the channel delay spread and avoid OFDM inter-symbol interference (ISI).

The data/information carried by each sub-carrier 150 may be user data of many forms, including text, voice, video, and the like. In addition, the data includes control data, a particular type of which is discussed below. As a result of the orthogonality, ideally each receiving element tuned to a given sub-carrier does not perceive any of the signals communicated at any other of the sub-carriers. Given this aspect, various benefits arise. For example, OFDM is able to use orthogonal sub-carriers and, as a result, thorough use is made of the overall OFDM spectrum. As another example, in many wireless systems, the same transmitted signal arrives at the receiver at different times having traveled different lengths due to reflections in the channel between the transmitter and receiver. Each different arrival of the same originally-transmitted signal is typically referred to as a multi-path. Typically, multi-paths interfere with one another, which is sometimes referred to as InterSymbol Interference (ISI) because each path includes transmitted data referred to as symbols. Nonetheless, the orthogonality implemented by OFDM with a CP considerably reduces or eliminates ISI and, as a result, often a less complex receiver structure, such as one without an equalizer (one-tap “equalizer” is used), may be implemented in an OFDM system.

The Cyclic Prefix (CP) (also referred to as guard interval) is added to each symbol to combat the channel delay spread and avoid ISI. FIG. 2 is a diagram illustrative of using CP to eliminate ISI and perform frequency domain equalization. Blocks 200 each comprising cyclic prefix (CP) 210 coupled to data symbols 220 to perform frequency domain equalization. OFDM typically allows the application of simple, 1-tap, frequency domain equalization (FDE) through the use of a CP 210 at every FFT processing block 200 to suppress multi-path interference. Two blocks are shown for drawing convenience. CP 210 eliminates inter-data-block interference and multi-access interference using Frequency Division Multiple Access (FDMA).

Since orthogonality is typically guaranteed between overlapping sub-carriers and between consecutive OFDM symbols in the presence of time/frequency dispersive channels, the data symbol density in the time-frequency plane can be maximized and high data rates can be very efficiently achieved for high Signal-to-Interference and Noise Ratios (SINR).

FIG. 3 is a diagram illustrative of CP Insertion. A number of samples is typically inserted between useful OFDM symbols 320 (guard interval) to combat OFDM ISI induced by channel dispersion, assist receiver synchronization, and aid spectral shaping. The guard interval 310 is typically a prefix that is inserted 350 at the beginning of the useful OFDM symbol (OFDM symbol without the CP) 320. The CP duration 315 should be sufficient to cover most of the delay-spread energy of a radio channel impulse response. It should also be as small as possible since it represents overhead and reduces OFDM efficiency. Prefix 310 is generated using a last block of samples 340 from the useful OFDM symbol 330 and is therefore a cyclic extension to the OFDM symbol (cyclic prefix).

When the channel delay spread exceeds the CP duration 315, the energy contained in the ISI should be much smaller than the useful OFDM symbol energy and therefore, the OFDM symbol duration 325 should be much larger than the channel delay spread. However, the OFDM symbol duration 325 should be smaller than the minimum channel coherence time in order to maintain the OFDM ability to combat fast temporal fading. Otherwise, the channel may not always be constant over the OFDM symbol and this may result in inter-sub-carrier orthogonality loss in fast fading channels. Since the channel coherence time is inversely proportional to the maximum Doppler shift (time-frequency duality), this implies that the symbol duration should be much smaller than the inverse of the maximum Doppler shift.

The large number of OFDM sub-carriers makes the bandwidth of individual sub-carriers small relative to the total signal bandwidth. With an adequate number of sub-carriers, the inter-carrier spacing is much narrower than the channel coherence bandwidth. Since the channel coherence bandwidth is inversely proportional to the channel delay spread, the sub-carrier separation is generally designed to be much smaller that the inverse of the channel coherence time. Then, the fading on each sub-carrier appears flat in frequency and this enables 1-tap frequency equalization, use of high order modulation, and effective utilization of multiple transmitter and receiver antenna techniques such as Multiple Input/Multiple Output (MIMO). Therefore, OFDM effectively converts a frequency-selective channel into a parallel collection of frequency flat sub-channels and enables a very simple receiver. Moreover, in order to combat Doppler effects, the inter-carrier spacing should be much larger than the maximum Doppler shift.

FIG. 4 shows the concepts of frequency diversity 400 and multi-user diversity 405. Using link adaptation techniques based on the estimated dynamic channel properties, the OFDM transmitter can adapt the transmitted signal to each User Equipment (UE) to match channel conditions and approach the ideal capacity of frequency-selective channel. Thanks to such properties as flattened channel per sub-carrier, high-order modulation, orthogonal sub-carriers, and MIMO; it is possible to improve spectrum utilization and increase achievable peak data rate in OFDM system. Also, OFDM can provide scalability for various channel bandwidths (i.e. 1.25, 2.5, 5, 10, 20 MHz) without significantly increasing complexity.

OFDM may be combined with Frequency Division Multiple Access (FDMA) in an Orthogonal Frequency Division Multiple Access (OFDMA) system to allow multiplexing of multiple UEs over the available bandwidth. Because OFDMA assigns UEs to isolated frequency sub-carriers, intra-cell interference may be avoided and high data rate may be achieved. The base station (or Node B) scheduler assigns physical channels based on Channel Quality Indication (CQI) feedback information from the UEs, thus effectively controlling the multiple-access mechanism in the cell. For example, in FIG. 4, transmission to each of the three UEs 401, 402, 403 is scheduled at frequency sub-bands where the channel frequency response allows for higher SINR relative to other sub-bands. This is represented by the Received signal levels R401, R402, and R403 for users 401, 402 and 403 at Frequencies F401, F402, and F403 respectively.

OFDM can use frequency-dependent scheduling with optimal per sub-band Modulation & Coding Scheme (MCS) selection. For each UE and each Transmission Time Interval (TTI), the Node B scheduler selects for transmission with the appropriate MCS a group of the active UEs in the cell, according to some criteria that typically incorporate the achievable SINR based on the CQI feedback. In addition, sub-carriers or group of sub-carriers may be reserved to transmit pilot, control signaling or other channels. Multiplexing may also be performed in the time dimension, as long as it occurs at the OFDM symbol rate or at a multiple of the symbol rate (i.e. from one TTI to the next). The MCS used for each sub-carrier or group of sub-carriers can also be changed at the corresponding rate, keeping the computational simplicity of the FFT-based implementation. This allows 2-dimensional time-frequency multiplexing, as shown in FIG. 5 and FIG. 6.

Transmission Time Interval (TTI) may also be referred to as a frame.

Turning now to FIG. 5, which is a diagram illustrative of a configuration for multi-user diversity. The minimum frequency sub-band used for frequency-dependent scheduling of a UE typically comprises several sub-carriers and may be referred to as a Resource Block (RB) 520. Reference number 520 is only pointing to one of the 8 RBs per OFDM symbol shown as example and for drawing clarity. RB 520 is shown with RB bandwidth 525 (typically comprising of a predetermined number of sub-carriers) in frequency dimension and time duration 510 (typically comprising of a predetermined number of OFDM symbols such as one TTI) in time dimension. Each RB may be comprised of continuous sub-carriers and thus be localized in nature to afford frequency-dependent scheduling. A high data rate UE may use several RBs within same TTI 530. UE #1 is shown as an example of a high rate UE. Low data rate UEs requiring few time-frequency resources may be multiplexed within the same RB 540 or, alternatively, the RB size may be selected to be small enough to accommodate the lowest expected data rate.

Alternatively referring to FIG. 6, which is a diagram illustrative of a configuration for frequency diversity, an RB 620 may correspond to a number of sub-carriers substantially occupying the entire bandwidth thereby offering frequency diversity. This may be useful in situations where CQI feedback is not available or it is unreliable (as is the case for high speed UEs). Another option to achieve frequency diversity is to assign to a UE two or more RBs with each RB comprising of contiguous sub-carriers but and with each RB occupying non-contiguous parts of the bandwidth.

By assigning transmission to various simultaneously scheduled UEs in different RBs, the Node B scheduler can provide intra-cell orthogonality among the various transmitted signals. Moreover, for each individual signal, the presence of the cyclic prefix provides protection from multipath propagation and maintains in this manner the signal orthogonality. Nevertheless, near the edge of each cell, the UEs are exposed to interference from the signals transmitted from Node Bs of adjacent cells to UEs near the edge of those cells. This interference (inter-cell interference) causes significant degradation in the SINR achieved by cell edge UEs and severely limits their potential performance. Conventional approaches in prior art attempt to address this problem by either applying hard frequency re-use, as in Global Systems for Mobile Communications GSM-type networks, or using interference cancellation, if it is possible and effective, as in Code Division Multiple Access CDMA-type networks.

Thus, there is a need for a system and method to avoid interference near edges of cells in a communication system.

### SUMMARY

Embodiments of the invention provide methods for assigning frequency and/or time resources to Node Bs for communication with a plurality of user equipments (UEs) at the cell edge in each Node B. A central node receives metrics indicating requirement for resources for communication with cell edge UEs and the central node communicates with each of the Node Bs information regarding these resources. Alternatively, the resources for communication with cell edge UEs may be assigned, without communication with a central node, based on long term statistics for cell edge data rate requirements in each Node B and be periodically re-configured. The aforementioned resources can be frequency resources, time resources, or both.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 is a diagram illustrative of the Frequency-Time Representation of an OFDM Signal;

FIG. 2 is a diagram illustrative of using cyclic prefix (CP) to eliminate ISI and perform frequency domain equalization;

FIG. 3 is a diagram illustrative of Cyclic Prefix (CP) Insertion

FIG. 4 shows the concepts of frequency and multi-user diversity;

FIG. 5 is a diagram illustrative of a configuration for Multi-User Diversity;

FIG. 6 is a diagram illustrative of a configuration for frequency diversity;

FIG. 7 shows an exemplary cell structure highlighting the cell edges;

FIG. 8 shows static interference co-ordination with fractional frequency (or time) reuse IC-FFR where the size of reserved frequency RBs is time invariant;

FIG. 9 is a diagram of exemplary User Equipment throughput requirements near cell edge;

FIG. 10 shows semi-static interference co-ordination with fractional frequency (or time) reuse IC-FFR time varying size of reserved frequency RBs; and

FIG. 11 shows semi-static combination of interference co-ordination with fractional frequency reuse IC-FFR and interference co-ordination with fractional time re-use IC-FTR time varying size of reserved frequency RBs and TTIs.

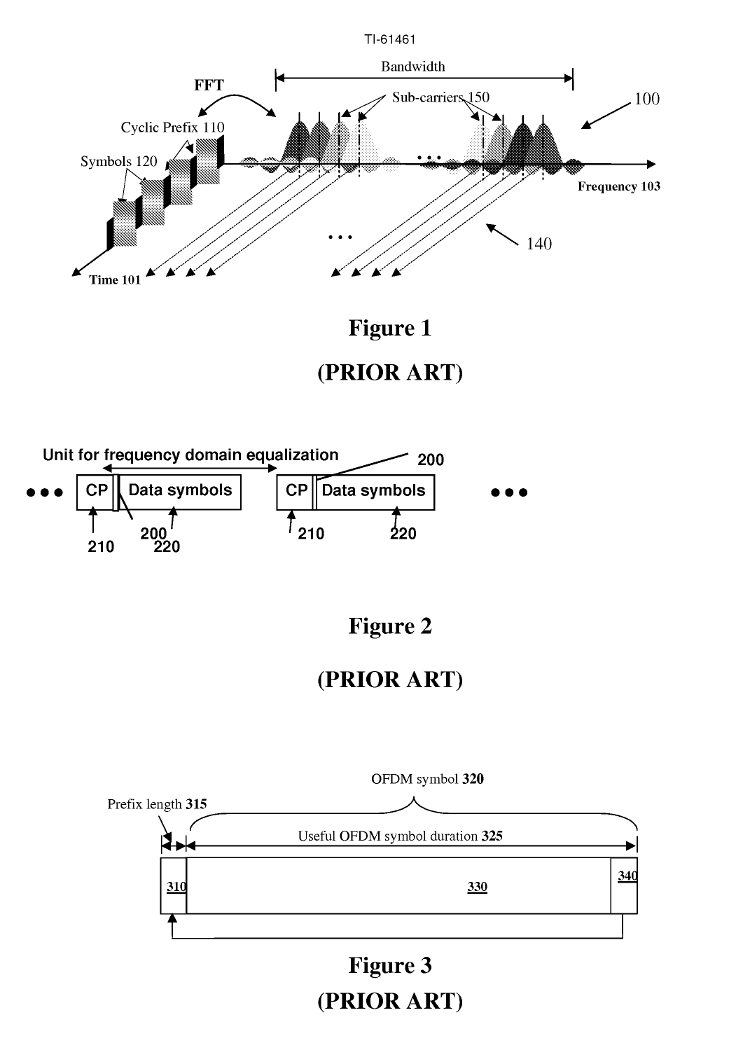

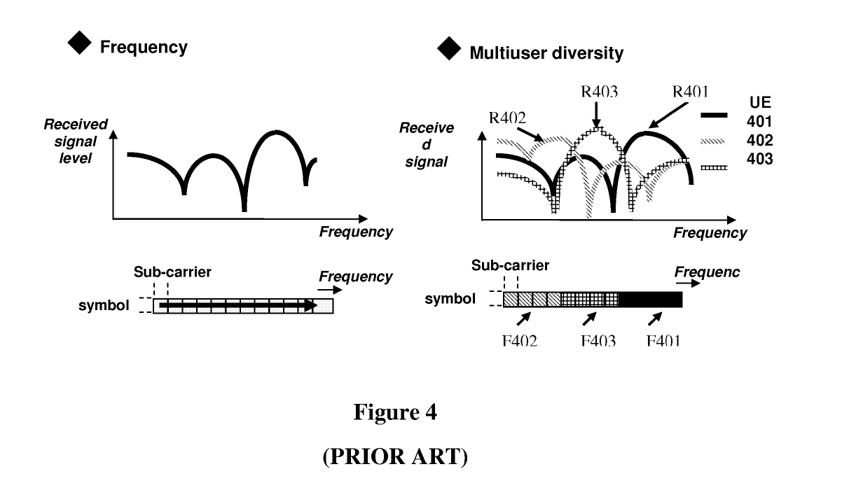

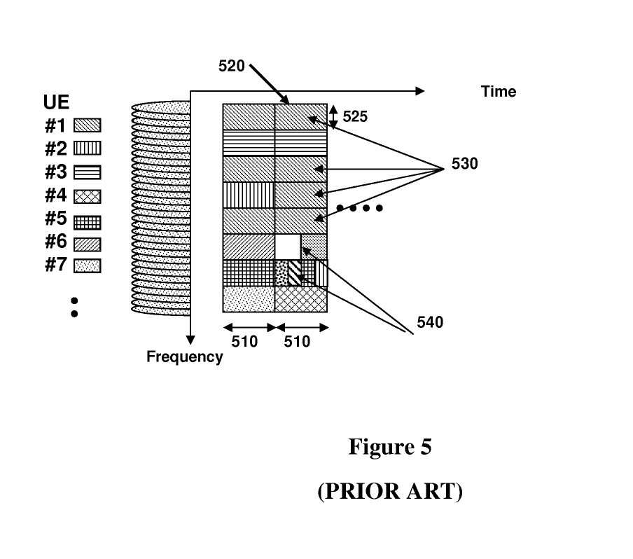

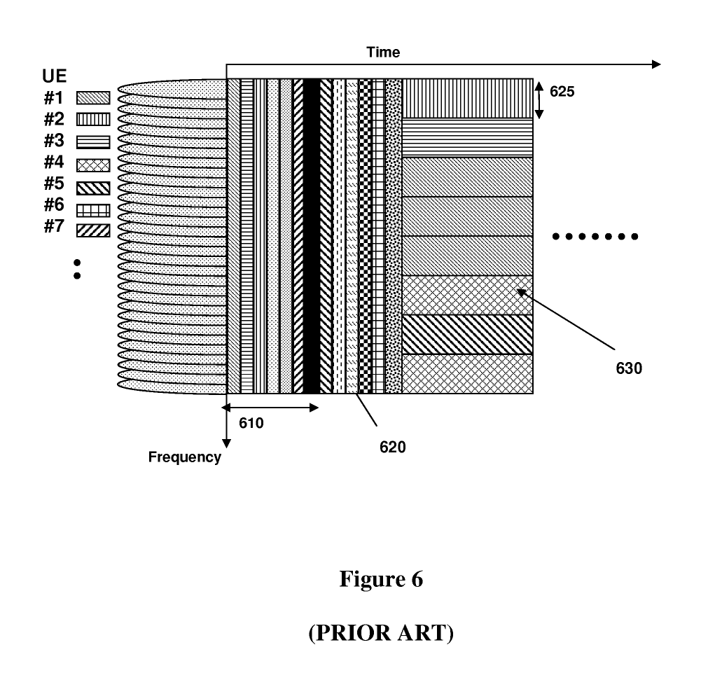

### DETAILED DESCRIPTION

It should be understood at the outset that although an exemplary implementation of one embodiment of the disclosure is illustrated below, the system may be implemented using any number of techniques, whether currently known or in existence. The disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the invention address the problem of inter-cell interference for UEs located near the edge of a cell having a serving Node B in OFDMA-based networks, including variants of the OFDMA transmission method such as the single-carrier FDMA (SC-FDMA) transmission method.

In order to satisfy a service quality that depends less on the UE location, it is important to consider methods providing inter-cell interference mitigation near the cell edge. Such an interference mitigation method is proposed based on soft fractional frequency reuse for the allocation of the frequency RBs in adjacent cells. This allocation is achieved through semi-static Node B coordination taking into account the traffic load, i.e. the distribution (location and/or transmit power requirements) and throughput requirements of UEs near the edge of each Node B. Knowing this traffic load information at the edge of each Node B in a network of Node Bs, a central unit, such as for example a master Node B or a radio network controller, can then allocate a set of RBs to each Node B. These RBs cannot be used with full transmission power by adjacent Node Bs to schedule UEs located near their corresponding edges. This means that in the RBs allocated to the referenced Node B, adjacent Node Bs transmit with much reduced power, including no transmission, to UEs located near their corresponding edges. However, all Node Bs use the entire bandwidth to schedule UEs in their interior (soft fractional frequency re-use).

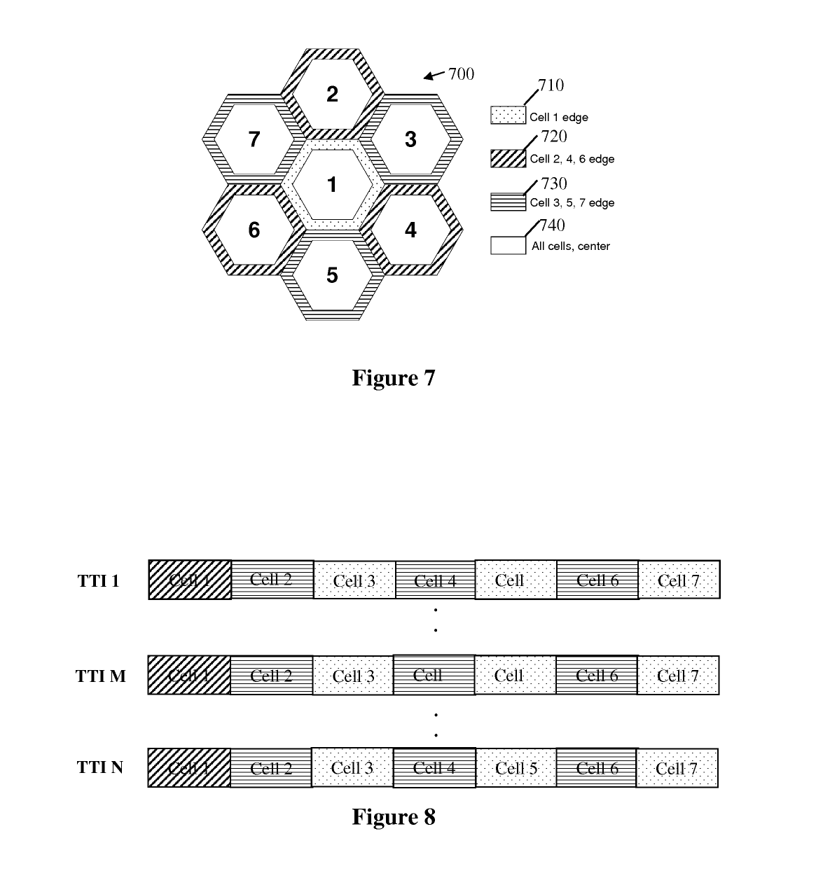

An exemplary application of the described interference co-ordination approach is shown in FIG. 7 for the exemplary setup of soft fractional frequency re-use of three. All Node Bs can use the entire available frequency spectrum to schedule UEs located in their interior but can only use a fraction of this spectrum to schedule UEs located near their edges. Adjacent Node Bs transmit with reduced power, including no transmission (zero power), in the fraction of the frequency spectrum allocated to the referenced Node B. Because of this fractional division of the available frequency spectrum for use near the cell edge, the corresponding methods will be referred to as interference co-ordination with fractional frequency reuse (IC-FFR) methods.

It should be noted that unlike the hard frequency re-use used in GSM-like networks, IC-FFR achieves a frequency re-use of one and therefore has no reduction in bandwidth efficiency. The power restrictions for transmissions from adjacent Node Bs in the RBs reserved for use by cell edge UEs in a reference Node B can be viewed as a scheduler restriction and not as a bandwidth one. For the example of FIG. 7, assuming that all Node Bs have uniform traffic load distributions throughout their coverage area, that the cells have equal sizes or equal propagation losses at their edges, and that the traffic load is the same at the edge of all cells, an appropriate division of the available frequency spectrum for use near the cell edge is in three equal portions. In FIG. 7, cell 1 is allocated one-third of that spectrum 710, cells 2, 4, and 6 are allocated a second one-third 720, and cells 3, 5, and 7 are allocated the final one-third 730. When the Node B scheduler of any of the previous cells schedules a set of UEs for transmission, it may assign the one-third of these scheduled UEs it determines to be located closer to the cell edge (than the remaining two-thirds of UEs) in the one-third of reserved RBs this reference Node B has been allocated. The remaining two-thirds of scheduled UEs, deemed to be located closer to the cell interior, are scheduled in the remaining two-thirds of the available spectrum.

Scheduling for UEs near the cell edge takes precedence over scheduling of UEs toward the cell interior, effectively making the available frequency RBs for scheduling of the latter between 100% (all UEs in the cell interior) to 67% of the total bandwidth (enough UEs exist near the cell edge with scheduling priority to occupy all reserved RBs, assuming the reserved RBs correspond to one-third of the total bandwidth). The determination whether the UE belongs to the cell interior or the cell edge can be based on existing channel quality information (CQI) reporting from each UE provided that the downlink reference signal (RS) occupies different sub-carriers in adjacent Node Bs. For example, relative to FIG. 7, the RS sub-carriers in Cell 1 may be spaced every six sub-carriers and start from the first sub-carrier of some OFDM symbols in a TTI. The RS sub-carriers for Cells 2 though 7 may have the same spacing but start from the second sub-carrier for Cells 2, 4, and 6, and from the third sub-carrier for Cells 3, 5, and 7. In general, having the RS sub-carriers from the aforementioned Cells (Node Bs) not overlap at least during some TTIs over the resource allocation update period will provide the desired information for UE classification. This is described in U.S. Provisional Patent Application Ser. No. 60/763,549, entitled “Signaling Requirements to Support Inter-cell Frequency Planning for Interference Mitigation in OFDM Based Systems,” filed on Jan. 31, 2006 (TI-62021). Said application hereby incorporated by reference

The transmit powers of the RS and data signal may or may not be the same. Having the downlink RS occupy different sub-carriers among adjacent cells, at least during some TTIs over the resource allocation update period, the CQI measurement in the various RBs, possibly averaged over several TTIs to combat short term fading, directly provides a measurement of the inter-cell interference experienced by each UE. This applies to both the shared control and data channels.

When a UE is in the cell edge, the CQI measurement in the reserved RBs is affected only by the interfering signals transmitted to cell interior UEs in adjacent Node Bs. The CQI measurement in the remaining RBs is affected by both interfering signals to cell edge and cell interior UEs in adjacent cells and has therefore typically smaller values.

Similar arguments apply for a UE in the cell interior. However, such a UE is much more insulated to inter-cell interference and the average CQI measurement is similar across all RBs. Notice that in this manner, the classification of a UE as a cell edge or a cell interior one is not so much a location-dependent one as an interference-dependent one (although the UE location is typically a determining factor).

Before describing the attributes of the disclosed invention for semi-static network IC-FFR to provide cell edge interference mitigation, an alternative, prior art, method of static IC-FFR is briefly reviewed to outline its shortcomings and help further clarify the motivation and benefits of the semi-static IC-FFR.

Purely static IC-FFR can often be highly sub-optimal because of changing UE traffic and throughput requirements characteristics. A set of frequency RBs (usually one-third of the total) is reserved by each Node B indefinitely for use near its cell edge and cannot be used with full transmission power in adjacent cells to schedule corresponding cell edge UEs. For fixed (same) data rate applications, such as voice service, if the UE distribution is uniform in each Node B in the network, static IC-FFR may be appropriate. However, in present and future wireless networks, various applications requiring substantially different data rates are supported and the throughput requirements may vary significantly among UEs, resulting to substantially varying traffic loads near the cell edges. For example, in one cell only a few UEs requiring low data rate applications, such as voice, may be located near the edge, while in another cell a few UEs with high data rate applications, such as video, may be located near the edge. The size (or number) of reserved RBs therefore needs to be different in these two cells and preferably analogous to the corresponding data rate requirements near the cell edge. In addition to its inability of having varying reserved RB sizes to reflect the varying traffic load requirements near the edges of cells in a network, static IC-FFR also requires cell planning in order to allocate the reserved RBs when the network is deployed so that adjacent cells are not allocated the same set of reserved RBs. Static IC-FFR also limits the peak rate that can be achieved by UEs near the cell edge of a Node B. Therefore, a static allocation without any reserved RB adaptation is not desirable for current and future wireless networks.

FIG. 8 shows a static IC-FFR where each Node B is allocated one-third of the total frequency band for use by its corresponding cell edge UEs. In accordance with FIG. 7, Cell 1 is allocated a first set of reserved frequency RBs, Cells 2, 4, and 6 are allocated a second set of reserved frequency RBs and Cells 3, 5, and 7 are allocated the third set of reserved frequency RBs. Notice that the one-third allocation of reserved RBs in FIG. 8 is exemplary and any other allocation could be possible (naturally, the total of the fractional frequency re-uses should be equal to one). Moreover, the RBs in the set of reserved RBs may not be contiguous in the frequency domain in order to enhance the possible frequency diversity in the set of reserved RBs. The RB allocation remains the same for all transmission time intervals (TTI).

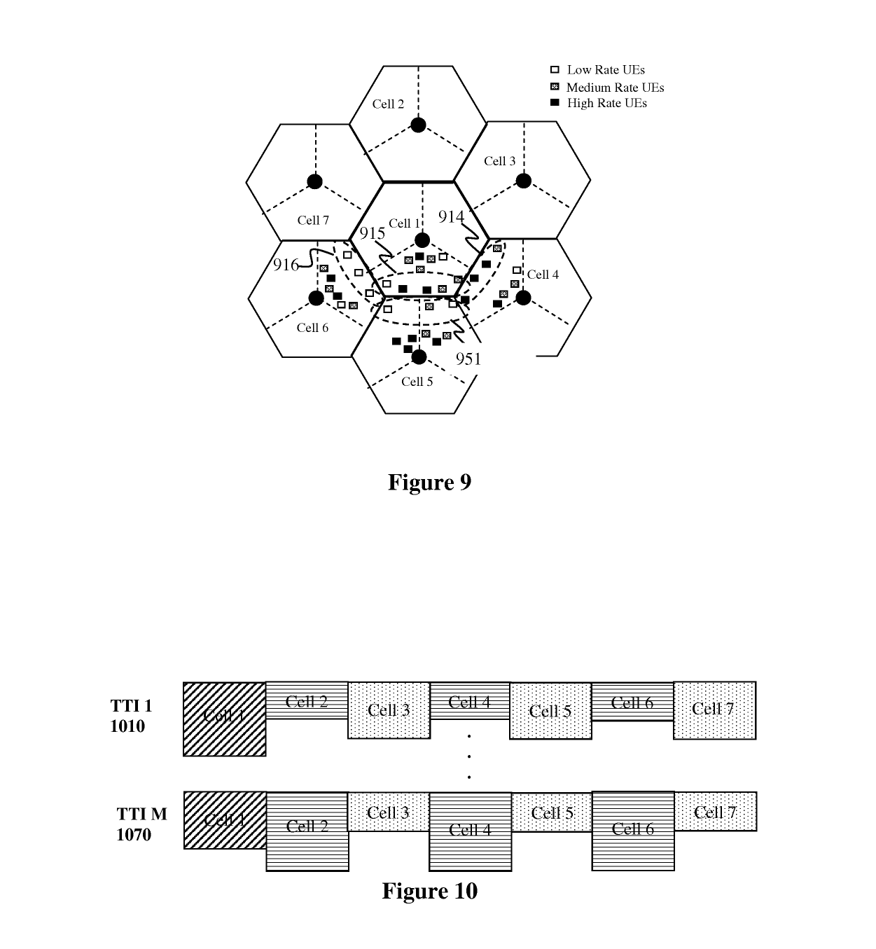

FIG. 9 shows a simplified exemplary case for the UE population and data rate requirements near the cell edges 915, 916, 914, 951 that nevertheless conveys the inefficiency of static IC-FFR in the case of varying traffic loads near the cell edge. In this exemplary setup, Cells 1 and 4 require a much larger number of reserved RBs than do Cells 5 and 6 and a static IC-FFR would be inappropriate. In this example, the cell edge 914 between cells 1 and 4 has a larger high data rate UE population then the other cell edges.

The described semi-static IC-FFR method avoids the shortcomings of the static one. Semi-static IC-FFR can more effectively address the varying traffic load and throughput requirements and UE populations near the various cell edges of a network. Moreover, cell planning may not be required to perform the allocation of reserved RBs to the various Node Bs in a network.

Semi-static IC-FFR can be achieved by the Node Bs communicating to a central node, such as a master Node B or to a radio network controller (RNC), metrics such as the traffic load, throughput requirements, inter-cell interference, and UE populations near the cell edge and with the central node communicating back to each Node B in the network of Node Bs the reserved frequency RBs for scheduling corresponding near cell edge UEs. Unlike purely static IC-FFR, the size of the reserved frequency RBs depends on metrics such as the overall traffic load and the traffic load near the cell edge in each Node B. The size of reserved frequency RBs can therefore vary from 0, in the case of negligible traffic load near the cell edge, to potentially significantly more than ⅓ of the total frequency band for high traffic loads near the cell edge. If adjacent Node Bs have similar traffic loads near their edges, the reserved resource allocation may be equally divided to near one-third of the total. If a Node B has larger traffic load near its edge than the adjacent Node Bs, the former can be allocated more than one-third of the reserved frequency resource for use at its edge. In this manner, the frequency resources are efficiently utilized while avoiding excessive interference for UEs near the cell edge.

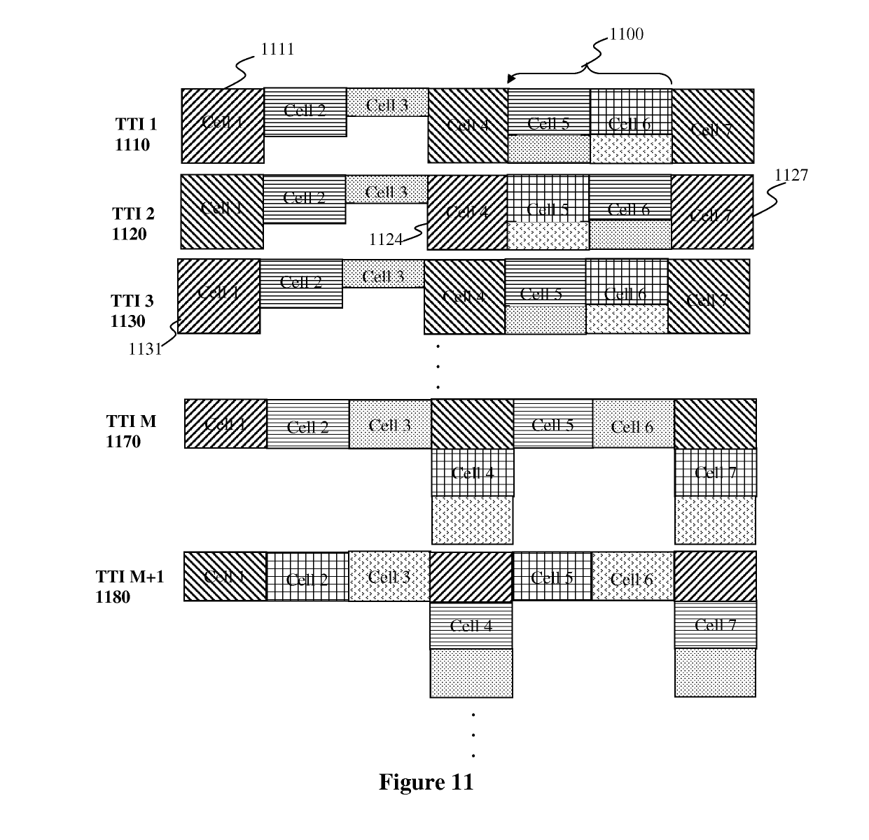

FIG. 10 illustrates the principle of semi-static IC-FFR where adjacent Node Bs (cells) are allocated different reserved RBs for scheduling of UEs near their edges. During the first allocation period of reserved frequency RBs, first transmission time interval (TTI) 1010, the traffic load near the edge of Cell 1 is greater than in the adjacent cells and Cell 1 is allocated the largest number of the reserved frequency RBs. Cells 3, 5, and 7 have medium traffic loads near their edge and are allocated a corresponding smaller number of reserved frequency RBs while Cells 2, 4, and 6 have the lowest traffic loads near their edge and are allocated the smallest number of reserved frequency RBs. For example, relative to the total frequency band, the percentage of reserved frequency RBs is 50% for Cell 1, 33.33% for Cells 3, 5, and 7, and 16.66% for Cells 2, 4, and 6.

During the next allocation period of reserved RBs (TTI M) 1070, Cells 2, 4, and 6 have the highest traffic loads near their edge and are accordingly allocated the largest number of reserved frequency RBs. Cell 1 has the second largest traffic load and Cells 3, 5, and 7 have the lowest traffic loads near their edges and are accordingly allocated reserved frequency RBs. For example, relative to the total frequency band, the percentage of reserved frequency RBs is 33.33% for Cell 1, 16.66% for Cells 3, 5, and 7, and 50% for Cells 2, 4, and 6. This exemplary allocation of reserved frequency RBs can be extended to an arbitrary number of cells where the central node performing the allocation considers the traffic load requirements near the cell edge for each group (Cell 1, Cells 2, 4, 6, and Cells 3, 5, 7 in FIG. 7). As there is an interaction among the allocations of reserved RBs in Node Bs, the traffic requirements at the cell edge can be viewed as combined ones for the above sets of Node Bs and not as individual ones.

Communication from Node Bs to the central node allocating the reserved RBs in each Node B in the network is to provide information regarding the throughput requirements at the cell edge, or alternatively the required reserved frequency sub-bands. Communication from the central node to each Node B in the network is to provide the corresponding allocation of reserved frequency RBs. This can be done at a very low rate since appreciable changes in the nature of service, the number of UEs and their location occur in the order of several seconds or even as infrequently as hours or days. The transmit power required for communication between Node B and UE may be used as a UE location metric instead of or in addition to the CQI reported by the UEs to the serving Node B. Scheduling of UEs near the cell edge is confined within the reserved frequency RBs (no such restriction exists for UEs located toward the cell interior but scheduling of the UEs near the cell edge is performed first).

In synchronous networks, interference mitigation can be achieved with time scheduling coordination for the TTIs leading to interference co-ordination through fractional time re-use (IC-FTR). Like IC-FFR, IC-FTR is simply the application of scheduler restrictions in order to schedule cell edge UEs only during particular TTIs where adjacent cells are allowed to schedule only cell interior UEs. Cell interior UEs are scheduled in every Node B in all TTIs. With stand-alone IC-FTR, the entire bandwidth is always used but cell edge UEs may be scheduled only specific TTIs allocated for cell edge use to the corresponding Node B. Cell interior UEs may or may not be scheduled during TTIs where cell edge UEs belonging to the same Node B are allowed to be scheduled. Unlike static FFR, no prior art exists for any form of IC-FTR.

IC-FFR and IC-FTR may also be combined to allow for enhanced flexibility in resource allocation and managing dynamic traffic loads near cell edges, thereby improving cell edge and overall throughput. Similar to IC-FFR, IC-FTR can be static or semi-static with the latter allowing for more efficient resource allocation. For example, considering FIG. 7 only from a static IC-FTR perspective (all frequency RBs available in every Node B), scheduling of cell edge UEs during a TTI for Cell 1, for Cells 2, 4, and 6, and for Cells 3, 5, and 7 may, respectively, occur only in TTIs for which TTI# modulo 3=0, TTI# modulo 3=1, and TTI# modulo 3=2. Similarly, considering FIG. 10 only from a semi-static IC-FTR perspective, during the first allocation period (first TTI), cell edge UEs in Cell 1 may be scheduled 50% of the time, in Cells 3, 5, and 7 may be scheduled 33.33% of the time and in Cells 2, 4, and 6 may be scheduled 16.67% of the time while during the second allocation period (after M TTIs), the corresponding numbers are 33.33%, 16.67% and 50%.

FIG. 11 illustrates semi-static IC-FFR and IC-FTR combination. During the first allocation period of time and frequency resources, Cells 1, 4, and 7 use the same reserved frequency RBs. Cell 1 is scheduled 1111 and 1131 during odd TTIs 1110 while Cells 4 and 7 are scheduled 1124 and 1127 respectively during even TTIs 1120. Cells 2 and 3 use the remaining reserved frequency RBs and are continuously scheduled. Cells 5 and 6 also use the remaining reserved frequency RBs and are alternately scheduled 1100. For example, the reserved frequency RBs for Cells 1, 4, 5, 6, and 7 are 50% of the total, for Cell 2 they are 33.33% of the total and for Cell 3 they are 16.67% of the total. In this example, Cell 2 has the largest traffic load requirements near its cell edge, Cells 1, 4, 5, 6, and 7 have similar ones, while Cell 3 has the smallest ones.

During the next allocation period (TTI M) 1070, Cells 1, 2, and 3 use different reserved RBs with size equal 33.33% of the total and Cells 5 and 6 use the same reserved frequency RBs as Cells 2 and 3, respectively. The previous Cells are scheduled during odd TTIs (TTI M=1 as example of the first odd TTI) 1180. Cells 4 and 7 reserve the entire frequency band and are scheduled during even TTIs. In this example, Cells 4 and 7 have the largest traffic load requirements near their edges while all remaining cells have similar ones. As it was previously mentioned, since there is an interaction among the allocations of reserved RBs in Node Bs (cells), the traffic requirements at the cell edge can be viewed as combined ones for the above sets of Node Bs and not as individual ones.

For IC-FTR, the CQI measurement at UEs near the cell edge during TTIs that these UEs are not scheduled by the serving Node B can be based on the transmission of orthogonal pilots, also known as reference signals, among adjacent Node Bs. This pilot orthogonality can be either in the time or in the frequency domain. The number of such orthogonal pilots depends on the type of frequency and time coordination. For example, considering FIG. 7, three orthogonal pilots among adjacent cells are needed (one for cell 1, one for cells 2, 4, and 6, and one for cells 3, 5, and 7). The exact procedure for using the CQI reporting to classify UEs to cell interior or cell edge ones in conjunction with interference co-ordination is described in U.S. Provisional Patent Application Ser. No. 60/763,549, entitled “Signaling Requirements to Support Inter-cell Frequency Planning for Interference Mitigation in OFDM Based Systems,” filed on Jan. 31, 2006 (TI-62021).

For the classification of UEs in cell interior or cell edge ones, the path loss or inter-cell interference measurements may also be considered.

With time scheduling, the Node B may also inform a UE at the cell edge of the TTI number the UE may potentially get scheduled by transmitting this low rate 1-4 bit information periodically once over the resource re-allocation period. Even for the static IC-FTR, a UE may have to be re-classified as a cell edge or cell interior one to account for UE movement in the Node B and changing UE distribution. In that manner, a cell edge UE will not be required to continuously monitor the shared control channel to determine whether it is scheduled in a TTI thereby enabling cell edge UEs for which battery power is most significant to conserve power. Therefore, cell edge UEs in a Node B may know in advance that they may get scheduled once every a certain number of TTIs, thereby enabling a sleep mode for these cell edge UEs in TTIs where no scheduling occurs.

In conclusion, two methods referred to as IC-FFR and IC-FTR were described in order to achieve interference avoidance near the cell edge for both the downlink and uplink of a wireless communication system. IC-FFR considers only semi-static frequency scheduling coordination. IC-FTR considers static or semi-static time scheduling coordination which may be combined with semi-static IC-FFR. The semi-static operation requires periodic re-configuration of the reserved resources (RBs) for use with priority from UEs located near the edge of each cell as decided by the corresponding serving Node B. This reconfiguration may be based on communication among the Node Bs in the network and a central node. The central node may be a master Node B or a radio network controller. The communication involves the Node Bs in the network informing the central node of a metric such as their traffic load requirements near their corresponding cell edge and the central node performing the corresponding assignment of reserved resources to each Node B. The communication rate can be in the order of several seconds. Alternatively, re-configuration of the reserved resources for scheduling cell edge UEs can be without any communication and may occur as infrequently as in the order of hours or days based on traffic load statistics near the cell edge.

With IC-FTR, cell edge and cell interior UEs may be informed of their classification in order to enable the former ones to monitor the shared control channel for potential scheduling only at pre-specified TTIs, with this TTI pattern also communicated to at least cell edge UEs, in order to enable a sleep mode for cell edge UEs during TTIs where no scheduling can occur and thereby conserve power for these cell edge UEs.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. In a cellular network having a plurality of Node Bs, a method to assign frequency resources to each of said Node Bs for communication with a plurality of user equipments (UEs) in each of said plurality of Node Bs, said method comprising:
receiving metrics indicating requirement for size of said frequency resources; and
communicating said frequency resources to each of said Node Bs.

2. The method of claim 1, wherein said metrics include the traffic load distribution or the inter-cell interference near the edge of each of said Node Bs.

3. The method of claim 1, wherein said assigned frequency resources to each of said Node Bs are used with priority for scheduling of said plurality of UEs near the edge of said each of said Node Bs.

4. The method of claim 1, wherein said communicating occurs in the order of several seconds.

5. In a cellular network comprising of a plurality of Node Bs, a method to assign frequency resources to each of said Node Bs for communication with a plurality of user equipments (UEs) in each of said Node Bs, said method comprising periodically re-configuring at each of said Node Bs the set of assigned frequency resources.

6. The method of claim 5, wherein said assigned frequency resources to each of said Node Bs are used with priority for the scheduling of UEs near the edge of said each of said Node Bs.

7. The method of claim 5, wherein said re-configuring occurs in the order of hours or days.

8. The method of claim 5, wherein said re-configuring is based on statistics of metrics collected between two successive re-configuring periods.

9. The method of claim 8, wherein said metrics include the traffic load distribution or inter-cell interference near the edge of said each Node B.

10. In a cellular network comprising a plurality of Node Bs, a method to assign time resources to each of said Node Bs for communication with a plurality of user equipments (UEs) in each of said Node Bs, said method comprising:
receiving metrics indicating requirement for size of said time resources; and
communicating said time resources to each of said Node Bs.

11. The method of claim 10, wherein said metrics include the traffic load distribution near the edge of each of said Node Bs.

12. The method of claim 10, wherein said assigned time resources to each of said Node Bs are used with priority for the scheduling of UEs near the edge of said each of said Node Bs.

13. The method of claim 10, wherein said communicating occurs in the order of several seconds.

14. In a cellular network comprising of several Node Bs, a method to assign time resources to each of said Node Bs for communication with a set of user equipments (UEs) in each of said Node Bs, comprising the step of periodically re-configuring at each of said Node Bs the set of assigned time resources.

15. The method of claim 14, wherein said assigned time resources to each of said Node Bs are used with priority for the scheduling of UEs near the edge of said each of said Node Bs.

16. The method of claim 14, wherein said re-configuring occurs in the order of hours or days.

17. The method of claim 14, wherein said re-configuring is based on statistics of metrics collected between two successive re-configuring periods.

18. The method of claim 17, wherein said metrics include the traffic load distribution or inter-cell interference near the edge of said each Node B.

19. In a cellular network comprising of several Node Bs, a method to assign time resources to each of said Node Bs for communication with a set of user equipments (UEs) in each of said Node Bs, comprising the step of statically configuring at each of said Node Bs the set of assigned time resources.

20. The method of claim 19, wherein said assigned time resources to each of said Node Bs are used with priority for the scheduling of UEs near the edge of said each of said Node Bs.

21. In a cellular network comprising of several Node Bs and applying cell edge interference co-ordination through fractional time re-use, in accordance to either of claims 10, 14, or 19, a method to conserve power for each UE in a set of UEs having a serving Node B from said several Node Bs comprising the steps of
The serving Node B signals to at least one UE in said set of UEs the time pattern of possible scheduling occasions
Said at least one UE is said set of UEs is in a sleep mode during scheduling instances where no scheduling for said at least one UE can occur based on said time pattern of possible scheduling occasions

22. The method of claim 21, wherein each UE in said set of UEs powers on to receive possible scheduling instructions from said serving Node B in accordance to said time pattern of said possible scheduling occasions.

23. The method of claim 21, wherein each of said UEs in said said of UEs is informed of said time pattern at a rate that is substantially the same as the rate of resource re-configuration in accordance to claims 10 and 14 or only once in accordance to claim 19.

24. The method of claim 25, wherein said serving Node B signals to each UE it communicates with, a classification placing said each UE in one of at least two different sets.

25. A method for combining IC-FFR with IC-FTR in accordance to any combination of claims 1 or 7 with claims 10, 14 or 19.

26. In a cellular network having a plurality of Node Bs, a method to assign frequency resources to each of said Node Bs for communication with a set of user equipments (UEs) in each of said plurality of Node Bs, said method comprising:
communicating to a central node metrics indicating requirement for size of said frequency resources;
receiving from said central node information regarding said frequency resources.

27. The method of claim 26, wherein said central node is a master Node B.

28. The method of claim 26, wherein said central node is a radio network controller.

29. The method of claim 26, wherein said metrics include the traffic load distribution or inter-cell interference near the edge of each of said Node Bs.

30. The method of claim 26, wherein said assigned frequency resources to each of said Node Bs are used with priority for a scheduling of said plurality of UEs near the edge of said each of said Node Bs.

31. In a cellular network comprising a plurality of Node Bs, a method to assign time resources to each of said Node Bs for communication with a plurality of user equipments (UEs) in each of said Node Bs, said method comprising:
communicating to a central node metrics indicating requirement for size of said time resources; and
receiving from said central node information regarding said time resources.

32. The method of claim 31, wherein said central node is a master Node B.

33. The method of claim 31, wherein said central node is a radio network controller.

34. The method of claim 31, wherein said metrics include the traffic load distribution or inter-cell interference near the edge of each of said Node Bs.

35. The method of claim 31, wherein said assigned time resources to each of said Node Bs are used with priority for the scheduling of UEs near the edge of said each of said Node Bs.
